(19) United States
(12) Patent Application Publication
(10) Pub. No.: US 2025/0200888 A1
(43) Pub. Date: Jun. 19, 2025

(54) MAP CONSTRUCTION METHOD, DEVICE, AND STORAGE MEDIUM

(71) Applicant: Beijing Zitiao Network Technology Co., Ltd., Beijing (CN)

(72) Inventors: Dikai FAN, Beijing (CN); Shuxue PENG, Beijing (CN); Zhanyi YAN, Beijing (CN)

(21) Appl. No.: 18/984,404

(22) Filed: Dec. 17, 2024

(30) Foreign Application Priority Data
Dec. 19, 2023 (CN) 202311756195.8
Mar. 15, 2024 (CN) 202410302901.X
May 21, 2024 (CN) 202410635086.9

(51) Int. Cl. G06T 17/05

(52) U.S. Cl. CPC G06T 17/05

(57) ABSTRACT

Embodiments of the present disclosure provide a map construction method, a device, and a storage medium. The method includes: receiving a first placement request, wherein the first placement request includes a first placement position of a first anchor in a target coordinate system; and determining, in response to a second region map not being located at a current moment, a boundary range of a first region map based on the first placement position and constructing the first region map based on the boundary range of the first region map, and binding the first anchor to the first region map, wherein the second region map is constructed based on a placement request for placing an anchor that is received before the current moment.

### CROSS-REFERENCE TO RELATED APPLICATION

This application claims priority to Chinese Patent Application No. 202410302901.X, filed on Mar. 15, 2024, Chinese Patent Application No. 202311756195.8, filed on Dec. 19, 2023, and Chinese Patent Application No. 202410635086.9, filed on May 21, 2024, which are incorporated herein by reference in its entirety as a part of this application.

### TECHNICAL FIELD

Embodiments of the present disclosure relate to a map construction method, a device, and a storage medium.

### BACKGROUND

As a basic function of extended reality (XR), such as augmented reality (AR) and mixed reality (MR), spatial anchors have been widely used on various mobile devices.

In the related art, an anchor map can be constructed for placing an anchor, based on a self-tracking pose of a mobile device.

However, the inventors have found that there are at least the following technical problems in the related art: because a self-tracking function of the mobile device usually has accumulated drift, there is also drift occurring in an anchor placed by a user.

### SUMMARY

Embodiments of the present disclosure provide a map construction method, a device, a storage medium, and a program product.

According to a first aspect, an embodiment of the present disclosure provides a map construction method. The method includes:
receiving a first placement request, where the first placement request includes a first placement position of a first anchor in a target coordinate system; and
determining, in response to a second region map not being located at a current moment, a boundary range of a first region map based on the first placement position and constructing the first region map based on the boundary range of the first region map, and binding the first anchor to the first region map, where the second region map is constructed based on a placement request for placing an anchor that is received before the current moment.

According to a second aspect, an embodiment of the present disclosure provides a map construction device. The device includes:
a receiving module configured to receive a first placement request, wherein the first placement request comprises a first placement position of a first anchor in a target coordinate system; and
a construction module configured to determine, in response to a second region map not being located at a current moment, a boundary range of a first region map based on the first placement position and constructing the first region map based on the boundary range of the first region map, and bind the first anchor to the first region map, wherein the second region map is constructed based on a placement request for placing an anchor that is received before the current moment.

According to a third aspect, an embodiment of the present disclosure provides an electronic device. The electronic device includes: a processor and a memory, where
the memory stores computer-executable instructions; and
the processor executes the computer-executable instructions stored in the memory, to cause the at least one processor to perform the map construction method according to the first aspect and various possible designs of the first aspect.

According to a fourth aspect, an embodiment of the present disclosure provides a computer-readable storage medium. The computer-readable storage medium stores computer-executable instructions that, when executed by a processor, cause the map construction method according to the first aspect and various possible designs of the first aspect to be implemented.

According to a fifth aspect, an embodiment of the present disclosure provides a computer program product including a computer program. When the computer program is executed by a processor, the map construction method according to the first aspect and various possible designs of the first aspect is implemented.

### BRIEF DESCRIPTION OF DRAWINGS

In order to describe the technical solutions in embodiments of the present disclosure or in the prior art more clearly, the accompanying drawings for describing the embodiments or the prior art will be briefly described below. Apparently, the accompanying drawings in the description below show some embodiments of the present disclosure, and those of ordinary skill in the art may still derive other accompanying drawings from these accompanying drawings without creative efforts.

FIG. 1A is a schematic diagram 1 of an application scenario of map construction according to an embodiment of the present disclosure;

FIG. 1B is a schematic diagram of another application scenario of map construction according to an embodiment of the present disclosure;

FIG. 1C is a schematic diagram of still another application scenario of map construction according to an embodiment of the present disclosure;

FIG. 2 is a schematic flowchart 1 of a map construction method according to an embodiment of the present disclosure;

FIG. 3 is a schematic diagram 2 of an application scenario of map construction according to an embodiment of the present disclosure;

FIG. 4 is a schematic diagram 3 of an application scenario of map construction according to an embodiment of the present disclosure;

FIG. 5 is a schematic flowchart 2 of a map construction method according to an embodiment of the present disclosure;

FIG. 6 is a schematic diagram 4 of an application scenario of map construction according to an embodiment of the present disclosure;

FIG. 7 is a schematic diagram of a first map according to an embodiment of the present disclosure;

FIG. 8 is a schematic diagram of an anchor map according to an embodiment of the present disclosure;

FIG. 9 is a schematic flowchart of a map construction method according to an embodiment of the present disclosure;

FIG. 10 is a schematic diagram of space division according to an embodiment of the present disclosure;

FIG. 11 is a schematic diagram of a top view of space division according to an embodiment of the present disclosure;

FIG. 12 is a block diagram of a structure of a map construction device according to an embodiment of the present disclosure; and

FIG. 13 is a block diagram of a hardware structure of a map construction device according to an embodiment of the present disclosure.

### DETAILED DESCRIPTION

In order to make the objectives, technical solutions, and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. All other embodiments obtained by those of ordinary skill in the art based on the embodiments of the present disclosure without any creative effort shall fall within the scope of protection of the present disclosure.

As a basic function of extended reality (XR), such as augmented reality (AR) and mixed reality (MR), spatial anchors have been widely used on various mobile devices. The function allows an application to create a frame of reference or a location point in a space so that a virtual object in the application can be stored in the space for a long time. Mapping can be performed for a usage scenario of a user based on spatial anchor technologies, and all virtual things are abstracted as a single point anchored in the constructed map. When a specific position of the user in the space is known, a relative relationship between the virtual anchor and a position of the user can be obtained based on the anchor map. For example, if a virtual clock is placed on a physical desktop, a position of the virtual clock can be fixed by an anchor. For example, in a game scenario, a game player may put a 3D chessboard in a space, and when power-on is performed after power-off, the 3D chessboard will still appear in the same spatial position, and the chess game can be resumed.

In the related art, a sparse point-cloud map and coordinate lines may be created for a space to be mapped, and an anchor map may be constructed based on a self-tracking pose (implemented by using such as a localization function or simultaneous localization and mapping (SLAM)) of a mobile device for placing an anchor.

However, because a self-tracking function of a mobile device in a complex environment usually has accumulated drift, there is also drift occurring in an anchor placed by a user. In addition, there is a large amount of map data, consuming a lot of computing power and storage resources. An excessively large usage scenario of the user may result in a slow map construction process, and occupy more internal memory and external memory, thereby affecting user experience.

In order to solve the technical problems described above, the inventors of the present disclosure have found that in the process of anchor map construction, it is required to perform the construction based on the self-tracking pose output by the mobile device. A larger area of the constructed map requires a larger amount of pose data, and leads to an accumulated drift error of the pose. Therefore, in order to reduce the accumulated error and impact of the accumulated error on an anchor, constructing a map only with a small area is sufficient for the creation of the anchor, which can not only reduce resources consumed for the map construction but also avoid the problem of anchor drift due to excessive accumulated drift of the pose.

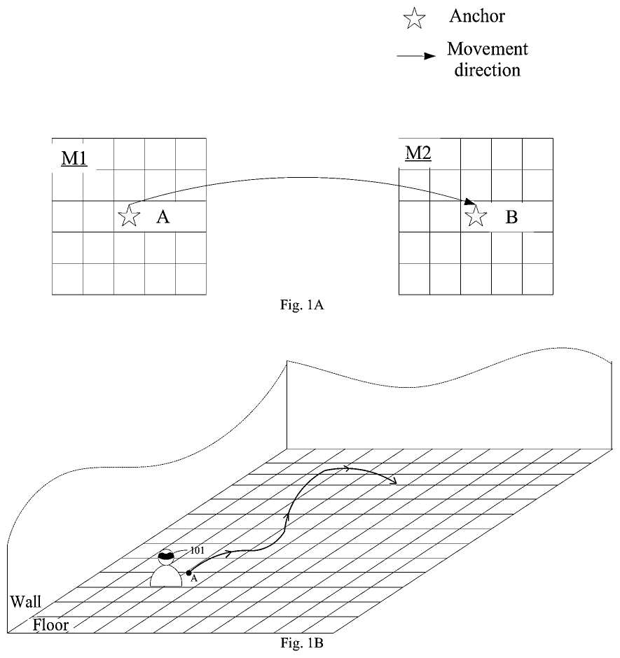

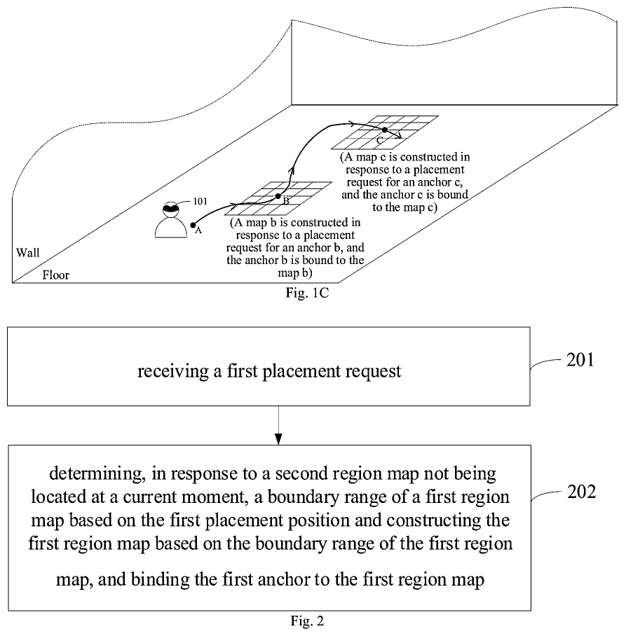

Referring to FIG. 1A, FIG. 1A is a schematic diagram of an application scenario of map construction according to an embodiment of the present disclosure. It is assumed that a second anchor is an anchor A, a second region map is a map M1, a first anchor is an anchor B, and a first region map is M2. An XR device can be worn by a user. When the XR device receives a placement request input by the user for the anchor A, a boundary range of the map M1 may be determined based on a placement position of the anchor A in the placement request, the map M1 may be constructed based on the boundary range of the map M1, the anchor A is bound to the map M1, and then localization may be performed based on the map M1. When a placement request for the anchor B is received, if a placement position of the anchor B is outside the boundary range of the map M1 and a new region map (a region map constructed based on a placement request for placing an anchor that is received before a current moment) is not located currently, a boundary range of the map M2 may be determined based on the placement position of the anchor B, and the map M2 may be constructed based on the boundary range of the map M2, and the anchor B may be bound to the map M2, and localization may be performed based on the map M2. According to the map construction method provided in this embodiment of the present disclosure, a self-tracking accumulated drift error of a device in a region map can be controlled by constructing the region map with a small area during the creation of an anchor, so as to reduce drift of anchors placed in the same region map.

In addition, during map construction, filtering may be performed on acquired images, and then a map may be constructed based on filtered images, which, compared to using a full amount of acquired image data for processing, can save resources and improve the efficiency of map construction.

Referring to FIG. 1B, FIG. 1B is a schematic diagram of another application scenario of map construction according to an embodiment of the present disclosure.

As shown in FIG. 1B, the user wears an XR device 101 and walks in a place (for example, an office area on a floor of an office building), and starting from a point A, map construction is performed while images are acquired during the walking. During map construction, a target region to be mapped may first be divided into grids, and filtering is performed on acquired images based on the grids, and then the map is constructed based on filtered images. According to the map construction method provided in this embodiment of the present disclosure, the region to be mapped is divided into grids and filtering is performed on the images based on the grids, and then the map is constructed based on a smaller number of filtered images, which can save resources and improve the efficiency of map construction.

The inventors of the present disclosure have also found that in the related art, a complete map is usually constructed for an entire space, which is another major reason for the low efficiency of map construction. In this regard, the inventors have found that no map construction needs to be performed when there is no need to place an anchor, and a map of a specific grid region is constructed only when an anchor is created, thereby improving the efficiency of map construction and saving resources.

Referring to FIG. 1C, FIG. 1C is a schematic diagram of still another application scenario of map construction according to an embodiment of the present disclosure. As shown in FIG. 1C, the user wears the XR device 101 and walks in a place (for example, the office area on a floor of an office building). Starting from the point A, no map construction is performed if there is no need to place an anchor, and if an anchor placement request b for placing an anchor b is received when the user walks to a point B, a region b may be determined based on the point B and a map b may be constructed based on the region b, and the anchor b may be bound to the map b. As the walking continues, if an anchor placement request c for placing an anchor c is received when the user walks to a point C, if the point C is outside the region b, a region c may be determined based on the point C, a map c may be constructed based on the region c, and the anchor c may be bound to the map c. During the construction of the map b and the map c, filtering is performed on acquired images, and then maps are constructed based on filtered images. According to the map construction method provided in this embodiment of the present disclosure, map construction is performed only when an anchor is created, and then the map is constructed based on a smaller number of filtered images, which, compared to the construction of a complete map for an entire space, can improve the efficiency of map construction and save resources.

Referring to FIG. 2, FIG. 2 is a schematic flowchart 1 of a map construction method according to an embodiment of the present disclosure. The method of this embodiment is applicable to a terminal device or a server. The map construction method includes the following steps.

201: receiving a first placement request.

For example, the first placement request includes a first placement position of a first anchor in a target coordinate system.

In this embodiment of the present disclosure, the target coordinate system may be a coordinate system for self-tracking and localization of an XR device such as an AR device or an MR device.

For example, the first placement request is used to instruct the placement of the first anchor. The first anchor may be used to mark and display a position in a world coordinate system, so that a virtual object may be placed at the position or rotated around the position, etc. A type of the first anchor may include, but is not limited to, a plane anchor, a box anchor, and a point anchor.

For example, the user wears the XR device, and the XR device receives the first placement request input to the XR device by the user through a touch operation, where the first placement request is used to indicate the coordinates of an anchor to be placed in a positioning coordinate system of the XR device.

202: determining, in response to a second region map not being located at a current moment, a boundary range of a first region map based on the first placement position and constructing the first region map based on the boundary range of the first region map, and binding the first anchor to the first region map.

For example, the second region map is constructed based on a placement request for placing an anchor that is received before the current moment.

For example, the second region map may be a region map previously constructed based on an anchor placement request and most recently located before the current moment, or may be a region map most recently constructed before the current moment and used for localization. In response to the second region map not being located at a current moment, the following cases may be included: the first placement position of the first anchor to be placed is outside a boundary range of the second region map; or although the first placement position of the first anchor to be placed is within the boundary range of the second region map, the XR device has not recognized that it has entered the boundary range of the second region map since it has just entered the second region map.

For example, in a scenario, after receiving a placement request for an anchor, the XR device may determine a boundary range of a second region map corresponding to the anchor based on a placement position of the anchor (e.g., a pose in the target coordinate system). Then, the second region map is constructed within the boundary range in real time based on a self-tracking pose (such as a pose of the target coordinate system) output by the XR device, and the anchor is bound to the second region map. If the first placement request of the first anchor is continuously received, it may be determined whether the first placement position of the first anchor is located in the newly constructed second region map. If the first placement position of the first anchor is not within the boundary range of the second region map, that is, the second region map cannot be located currently, it indicates that a region map needs to be constructed for the new anchor, and then the boundary range of the first region map may be determined based on the first placement position of the first anchor, and the first region map may be constructed based on the boundary range, and the first anchor may be bound to the first region map.

If power-on is subsequently performed after power-off, based on stored binding information, the respective bound anchors may be displayed separately in the constructed maps with smaller areas such as the first region map and the second region map.

In an embodiment of the present disclosure, there may be a plurality of ways to construct a map.

For example, when the user is walking while wearing the XR device, the XR device may provide a 6-degree-of-freedom (DOF) pose by filtering or other means, and obtain an image frame through one or more cameras provided on the XR device. During the map construction, a feature point (e.g., an edge point or a corner point) may be extracted first from an obtained image frame, and a bag of words is generated based on the extracted feature point (e.g., each feature point may correspond to one description, and for each image frame, a bag of words corresponding to the image frame is generated based on descriptions for a plurality of feature points of the image frame). After the bags of words respectively corresponding to the image frames are obtained, an epipolar search may be performed based on the determined 6 DOF pose and the generated bags of words to obtain matched feature points between different image frames, and then a three-dimensional point cloud is generated to perform multi-frame point cloud triangulation, and finally bundle adjustment (BA) is performed based on a triangulated point cloud to construct a region map.

In the process of localization based on the constructed region map, a feature point may be extracted from an image frame obtained by the camera of the XR device; a bag of words corresponding to the image frame may be generated based on the extracted feature point; based on the bag of words, a target image frame corresponding to a current image frame is searched in bags of words of historical image frames corresponding to the region map; based on feature point matching of the target image frame, a three-dimensional feature point that corresponds to a two-dimensional feature point of the current image frame in the point cloud of the region map may be obtained, and then a pose of the camera in the region map may be obtained through calculation based on a PNP algorithm. In order to ensure accuracy of a localization result, multi-frame consistency determination may be performed.

For example, in an embodiment, a region determined based on the boundary range of the first region map is divided into a plurality of grids, and the first region map is constructed based on image frame data stored in association with each grid. For details, reference may be made to the following.

It should be noted that the map construction algorithm and localization algorithm described above are only examples and other algorithms may be used, which is not limited in the embodiment of the present disclosure.

In an embodiment of the present disclosure, after the first placement request is received, the map construction method may further include: in response to the second region map being located at the current moment, binding the first anchor to the second region map.

Specifically, the second region map may be a most recently constructed region map or a previously constructed region map. If it is determined that the placement position of the first anchor is within the boundary range of the second region map, the first anchor may be bound to the second region map. Since the boundary range of the second region map can be controlled within a small range, an anchor placed within the region map will not drift significantly, thereby ensuring the accuracy of localization.

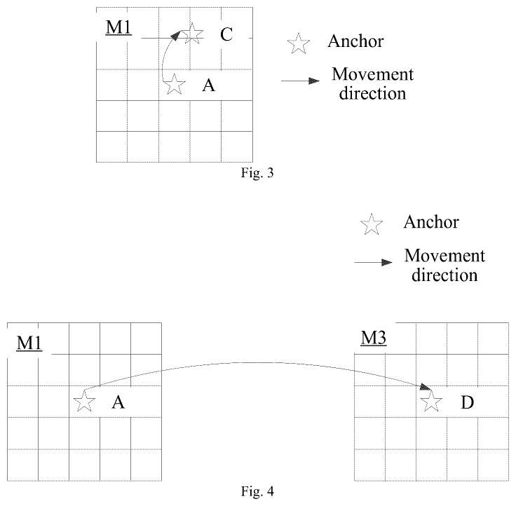

For example, as shown in FIG. 3, it is assumed that the second anchor is the anchor A, the second region map is the map M1, and the first anchor is an anchor C. The XR device can be worn by the user. When the XR device receives a placement request input by the user for the anchor A, the boundary range of the map M1 may be determined based on the placement position of the anchor A in the placement request, the map M1 may be constructed based on the boundary range of the map M1, the anchor A is bound to the map M1, and then localization may be performed based on the map M1. When a placement request for the anchor C is received, if a placement position of the anchor C is within the boundary range of the map M1, the anchor C may be bound to the map M1, and localization may be continued based on the map M1. According to the map construction method provided in this embodiment of the present disclosure, a self-tracking accumulated drift error of a device in a region map can be controlled by constructing the region map with a small area during the creation of an anchor, and by placing the anchor within the most recently constructed region map, so as to reduce drift of anchors placed in the same region map.

In an embodiment of the present disclosure, the determining a boundary range of a first region map based on the first placement position may include: determining the boundary range of the first region map by using the first placement position as a center.

For example, the boundary range may be a range in different shapes such as a circle or a square, and the specific shape may be selected according to actual needs, which is not limited in the embodiment of the present disclosure.

In an embodiment of the present disclosure, the binding the first anchor to the first region map may include: determining a target position of the first anchor in a map coordinate system of the first region map based on the first placement position and a transformation relationship between the map coordinate system of the first region map and the target coordinate system, and placing the first anchor based on the target position.

Specifically, the XR device uses the target coordinate system for self-tracking. The placement request for placing an anchor usually includes a placement position in the target coordinate system. A map coordinate system is usually used for map construction, and the map construction is performed based on a self-tracking pose. Therefore, a transformation relationship between the map coordinate system and the target coordinate system of the XR device may be obtained. A placement position of an anchor in the target coordinate system may be transformed to a placement position in the map coordinate system based on a transformation relationship between the target coordinate system and the map coordinate system. When power-on is performed after power-off, a previously placed anchor may be displayed based on the placement position in the map coordinate system. Because the region map has a small area, the drift of anchors placed based on the region map may be controlled within a specific range.

In an embodiment of the present disclosure, the boundary range of the first region map has a corresponding maximum accumulated drift error less than a preset threshold.

Specifically, an accumulated drift of the self-tracking pose of the XR device increases with an increase in walking distance. Therefore, the accumulated drift of the self-tracking pose obtained within a specific range may be less than the preset threshold. On this basis, a boundary range of the region map may be determined to avoid excessive drift of anchors placed in the region map.

It can be learned from the above description that the self-tracking accumulated drift error of the device in the region map can be controlled by constructing the region map with a small area during the creation of an anchor, so as to reduce drift of anchors placed in the same region map.

In an embodiment of the present disclosure, the second region map is a previously constructed historical region map. The user wears the XR device to enter the boundary range of the second region map again, and then the second region map is located. At this time, if the placement request for the first anchor is received, and the placement position of the first anchor is within the boundary range of the second region map, the first anchor may be bound to the second region map. The second region map is constructed based on the placement request for the anchor.

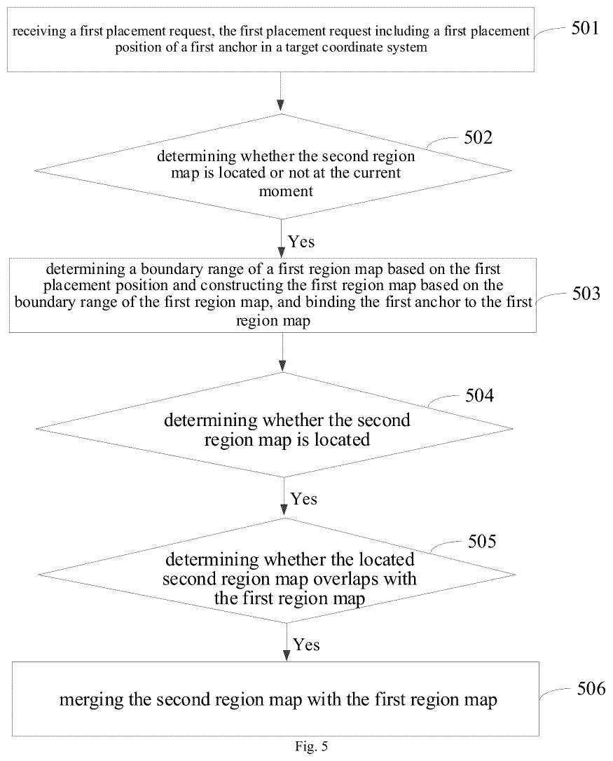

For example, as shown in FIG. 4, it is assumed that the second anchor is the anchor A, the first region map is the map M1, the first anchor is an anchor D, and the second region map is M3. The XR device can be worn by the user. When the XR device receives a placement request input by the user for the anchor A, the boundary range of the map M1 may be determined based on the placement position of the anchor A in the placement request, the map M1 may be constructed based on the boundary range of the map M1, the anchor A is bound to the map M1, and then localization may be performed based on the map M1. When a placement request for the anchor D is received, if the constructed map M3 (the M3 is constructed based on a placement request for placing an anchor that is received before the current moment) is located currently, and a placement position of the anchor D is within a boundary range of the map M3, the anchor D is bound to the map M3. According to the map construction method provided in this embodiment of the present disclosure, a self-tracking accumulated drift error of a device in a region map can be controlled by constructing the region map with a small area during creation of an anchor, and by placing the anchor within the constructed region map, so as to reduce drift of anchors placed in the same region map.

Referring to FIG. 5, FIG. 5 is a schematic flowchart 2 of a map construction method according to an embodiment of the present disclosure. A process of map merging is exemplified in this embodiment, and the map construction method includes the following steps.

501: receiving a first placement request, the first placement request including a first placement position of a first anchor in a target coordinate system.

502: determining whether the second region map is located or not at the current moment.

If yes, step 503 is performed. Here, the second region map is constructed based on a placement request for placing an anchor that is received before the current moment.

503: determining a boundary range of a first region map based on the first placement position and constructing the first region map based on the boundary range of the first region map, and binding the first anchor to the first region map.

504: determining whether the second region map is located.

If yes, step 505 is performed.

505: determining whether the located second region map overlaps with the first region map.

If the located second region map overlaps with the first region map, step 506 is performed.

506: merging the second region map with the first region map.

Specifically, because it takes a specific amount of time to complete the map construction and localization algorithm, there may be a case in which after a new region map is constructed based on an anchor placement request, it is found that a constructed map is located, and the constructed region map overlaps with the newly constructed region map. In order to prevent an anchor from being placed inaccurately or a large drift error between placed anchors due to a large error in an overlapping portion of the maps, the two maps need to be merged. In order to ensure the precision of a merged map, the maps may be corrected before merging. During the correction process, the newly constructed map and the constructed map may be corrected at the same time, or one of the maps may be selected for correction.

Optionally, if the second region map is located, but there is no overlapping between the two maps, no merging is performed.

Optionally, if the second region map is not located, even though there is overlapping between the second region map and the first region map, there is no need to merge them at this point.

In an embodiment of the present disclosure, considering that the accumulated drift is getting larger and larger, there is a relatively large error in the newly constructed map, and the constructed map may be fixed before merging and the newly constructed map may be corrected. Specifically, the merging the second region map with the first region map may include: correcting the first region map to merge a corrected first region map with the second region map.

In an embodiment of the present disclosure, the correcting the first region map may include: determining a plurality of historical region maps constructed between the last locating of the second region map and the current locating of the second region map, where the historical region map is constructed based on the placement request for placing the anchor; constructing a total error function based on a loop closure formed by an origin of a map coordinate system of the second region map and origins of map coordinate systems of the plurality of historical region maps; obtaining, through calculation, a target pose transformation relationship, between a map coordinate system of the first region map and the target coordinate system, that minimizes the total error function; and determining the corrected first region map based on the target pose transformation relationship, where the target coordinate system is a coordinate system for self-tracking and localization.

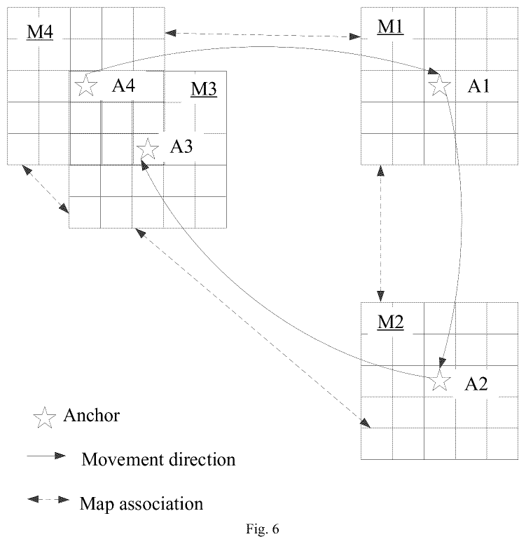

For example, as shown in FIG. 6, it is assumed that the second region map is M4. After M4 is constructed, the maps M1, M2, and M3 are constructed. After M4 is located again, it is found that there is overlapping between M3 and M4. In this case, M3 and M4 need to be merged, and the historical region maps are the map M1 to the map M3. Before M3 and M4 are merged, a transformation relationship between a map coordinate system of M4 and the target coordinate system may be fixed, and a transformation relationship between map coordinate systems respectively corresponding to M1, M2, and M3 and the target coordinate system may be adjusted. In this way, a total error of a loop closure formed by using M1, M2, M3, and M4 may be evenly distributed.

In an embodiment of the present disclosure, constructing the total error function based on the loop closure formed by using the second region map and the plurality of historical region maps may include: obtaining at least one first pose transformation relationship that respectively corresponds to at least one adjacent map pair, wherein each adjacent map pair comprises two adjacent region maps in the plurality of historical region maps and the second region map, and the first pose transformation relationship corresponding to the adjacent map pair is a pose transformation relationship between map coordinate systems of the two adjacent region maps; for each of the at least one adjacent map pair, determining an accumulated error term corresponding to the adjacent map pair based on the first pose transformation relationship corresponding to the adjacent map pair and a second pose transformation relationship between the map coordinate system corresponding to each of the two region maps and the target coordinate system; and determining the total error function based on the accumulated error term respectively corresponding to the at least one adjacent map pair.

For example, when maps are merged, map associations are usually connected into a loop. When the loop is formed by the associations, a localization error may cause misalignment of the associations in the loop. As shown in FIGS. 6, M1, M2, M3, and M4 are connected into a loop, and M1 and M2, M2 and M3, M3 and M4, and M4 and M1 are all adjacent maps. There are many ways to determine a pose transformation relationship between origins of map coordinate systems respectively corresponding to two maps in a adjacent map pair. For example, it may be determined based on the self-tracking pose provided by the XR device, or may be determined based on sensor data obtained by sensors such as an inertial measurement unit (IMU) provided in the XR device. There is a pose transformation relationship between the origin of the map coordinate system of M4 and the origin of the map coordinate system of M1, a pose transformation relationship between the origin of the map coordinate system of M1 and the origin of the map coordinate system of M2, a pose transformation relationship between the origin of the map coordinate system of M2 and the origin of the map coordinate system of M3, and a pose transformation relationship between the origin of the map coordinate system of M3 and the origin of the map coordinate system of M4. If no error exists, a product of rotation matrices in the four transformation relationships should be a unit matrix, and a sum of translations should be zero. However, the existence of the accumulated drift error causes a localization error, so that the product of the rotation matrices may not be a unit matrix, and the sum of the translations may not be zero. Therefore, it is required to globally correct the loop closure formed by using the maps to evenly distribute the error.

Assuming that a region map currently used for localization is M4, in order to prevent anchor precision for current localization from being affected, a transformation relationship between the map coordinate system of the map M4 currently used for localization and the target coordinate system may be fixed. By locating a relationship of edges formed by origins of given map coordinate systems, nonlinear optimization is constructed, and finally the transformation relationship between the map coordinate systems of the non-currently located maps (M1, M2, and M3) and the target coordinate system is calculated, so as to update a pose of the origin of each map coordinate system, and finally to realize the even distribution of the error.

It is assumed that a transformation relationship between a map Mi and the target coordinate system is Rᵢ, _{w}tᵢ, where Rᵢ and _{w}tᵢ respectively represent a rotation matrix and translation. For an edge ij between an origin of the map Mi and an origin of a map Mj, an error may be defined as:

$${e}_{ij} = ( \begin{matrix}Log ( {R}_{j}^{T} {R}_{i} {R}_{ij} ) \\ {}_{w} {t}_{i} + {}_{w} {t}_{ij} - {}_{w} {t}_{j}\end{matrix} ) \qquad ( 1 )$$

Further, all edges in a loop closure may be traversed for the total error:

$$err = {\sum }_{{e}_{ij} ∈ E} {e}_{ij}^{T} {e}_{ij} \qquad ( 2 )$$

A final optimization minimizes the total error err, thereby obtaining rotation and translation corresponding to the origins of the map coordinate systems of the maps M1, M2, and M3, and thus obtaining the corrected map M1. Further, after merging M1 and M4, the error caused by self-tracking drift in a merged map is corrected. During the error correction process, there is no need to optimize all trajectory data in the loop closure, which greatly reduces the amount of calculation.

It can be learned from the above description that the self-tracking accumulated drift error of the device in the region map can be controlled by constructing the region map with a small area during creation of an anchor, so as to reduce the drift of anchors placed in the same region map, and by merging the associated region maps, it can be ensured that the drift of the anchors placed in the merged map is controlled within a reasonable range.

For example, in some embodiments, taking the scenario shown in FIG. 1B and FIG. 1C as an example, the region entered by the user wearing the XR device is used as the target region, which is, for example, a room or a floor of a mall.

The user usually walks horizontally when moving in the target region, and thus has not much movement in a height direction. Therefore, although a SLAM system carried by the XR device can obtain three-dimensional spatial coordinates including a z-axis representing a direction of gravity, and an x-axis and a y-axis in a horizontal direction perpendicular to the direction of gravity, the target region in this embodiment is usually a region within a horizontal plane defined by the x-axis and the y axis. Grid division is also performed on the horizontal plane of the x and y axes, such as the ground shown in FIG. 1B.

For example, the target region may be divided into a plurality of grids.

For example, the target region may include a region determined based on the boundary range of the first region map.

For example, the constructing the first region map based on the boundary range of the first region map may include: storing a first preset number of frames or fewer frames of image frame data in association with each square; and constructing the first region map based on the image frame data stored in association with each of the plurality of squares.

Considering that the user may move back and forth in a small region while walking, there may be a large number of images acquired in the region. However, the precision of map construction does not increase infinitely with the number of images. On the contrary, the large number of images will occupy a large storage space and slow down the map construction process. Therefore, in order to better balance the precision of map construction and resource waste, a number of frames of image frame data stored in association with each grid may be limited.

Image frame data is in a one-to-one correspondence with image frames, and the image frame data includes two-dimensional coordinates of a feature point in a corresponding image frame, three-dimensional coordinates of a spatial point corresponding to the feature point, and a descriptor of the corresponding image frame and a pose with which the image frame is acquired.

For example, a number of frames of image frame data stored in association with each grid may be limited to 30 to 40.

Filtering of the image frame data may be performed based on the following temporal order: storing all acquired images first and then deleting images, or storing an image when it is acquired until a preset number is reached and then storing in association is stopped, which is not limited in this embodiment.

For example, there may be a plurality of ways to perform filtering of the image frame data. In a feasible implementation, the filtering may be performed based on an acquisition position of the image frame data. For example, a plurality of frames of image frame data having similar acquisition positions may be filtered. It is assumed that there are 30 frames of images acquired within a region with an area of 30 square centimeters, and only 10 frames of images may be retained. In order to ensure a uniform distribution of the image frame data, the region with the area of 30 square centimeters may be further divided to obtain 10 subregions, with one frame of image retained for each subregion.

In another feasible implementation, the filtering may be performed based on an orientation angle corresponding to the image frame data. Specifically, the storing image frame data in association with the grid may include: for each grid, assigning a plurality of orientation ranges to the grid, where each orientation range represents a range to which an orientation angle corresponding to the image frame data belongs; and storing image frame data in association with each orientation range in each grid, wherein a number of frames in the image frame data is less than or equal to a second preset number, where the second preset number is less than the first preset number.

In this embodiment, an angular difference between two endpoints may be equal for a plurality of orientation ranges. The angular difference may be set to range from 25 degrees to 50 degrees. There is no overlapping between different orientation ranges.

In an embodiment of the present disclosure, each grid in the first region map includes at least one sector region with a center of the grid as a center of a circle and with a central angle being a preset angle, and different sector regions correspond to different orientation angles; and after the constructing the first region map based on the image frame data stored in association with each of the plurality of grids, the method further includes: for each sector region, displaying the sector region distinguishably based on a number of frames of image frame data stored in association with the sector region.

For example, the target region (or the region determined based on the boundary range of the first region map) is a region within a plane perpendicular to the direction of gravity, and a sector region for a corresponding grid is obtained through the division of 360 degrees in the plane, i.e. an orientation angle is an angle of circumference perpendicular to the direction of gravity.

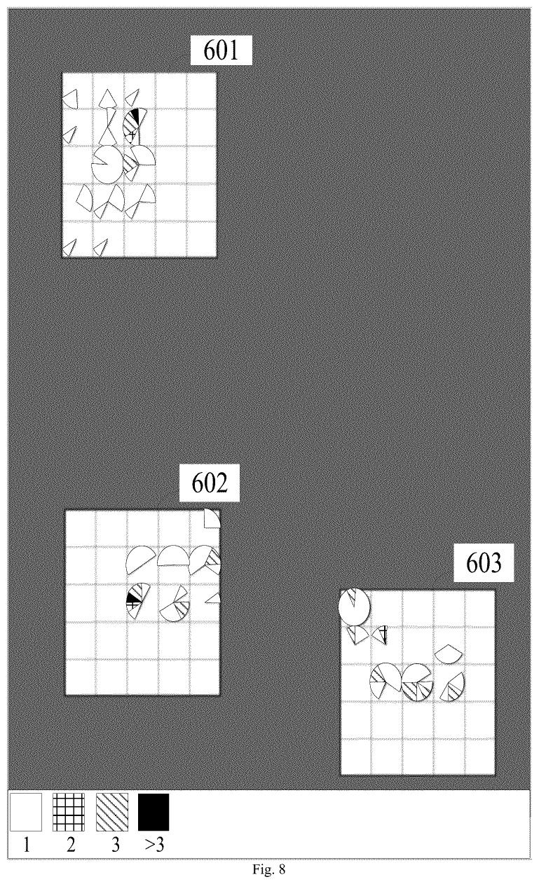

In an embodiment of the present disclosure, the distinguishable display of different numbers of frames of image frame data may be based on different fill patterns representing different numbers. As shown in FIG. 8, the area with black border and white background represents that one frame of image is stored, the area shaded by a grid shape represents that two frames of images are stored, the area with diagonal shading represents that three frames of images are stored, and black represents that there are more than three frames of images, which reaches a threshold, and no more image can be stored. The distinguishable display may further be implemented based on different colors, different values, etc.

For example, when constructing the first region map based on the image frame data stored in association with each of the plurality of grids, as an increasing number of frames of image frame data are stored in association with the grid, existing map construction techniques such as front-end feature point extraction and matching, triangulation, and BA may be used to construct a target map based on the image frame data stored in association with the grid.

On the basis of the above embodiments, in order to further solve the problem of inefficient map construction, there is provided a technical feature of determining a region with a small area based on an anchor placement position to construct a map within the region, to improve the efficiency of map construction.

For example, a map construction method according to at least one embodiment of the present disclosure further includes: obtaining a target region, where the target region includes a first region and a second region, and the target region is divided into a plurality of grids; in response to a target object being currently located outside the second region, obtaining a current position of the target object, and determining the first region based on the current position, where the first region is divided into a plurality of grids, and the second region is determined in response to receiving a second placement request; storing a first preset number of frames or fewer frames of image frame data in association with each grid; and constructing a first map based on the image frame data stored in association with each of the plurality of grids in the first region, and binding the first anchor to the first map.

As mentioned above, the region entered by the user wearing the XR device may be used as the target region.

For example, the target object may be the user wearing the XR device, etc. The current position of the target object is the position where the target object is currently reached by walking, that is, the position where the XR device worn by the user is currently located.

For example, taking the XR device as an example, the user wears the XR device and walks in a space, and when the first placement request for placing the first anchor is received, the current position may be obtained by a SLAM system carried by the XR device itself, and it is determined whether the user has stepped out of the second region, and if the current position is outside the second region, the first region may be determined based on the current position.

For example, the determining the first region based on the current position may include: constructing the first region with the current position as a center. Constructing the first region with the current position as a center allows image frame data to be further obtained regardless of a next walking direction of the user, which facilitates acquisition of more images for the precise construction of the first map.

For example, the determining the first region based on the current position may include: predicting a moving direction of the target object, constructing an ellipse with the current position as a first focus and with a point separated by a preset length from the current position in the moving direction as a second focus, and using the elliptical region as the first region. The moving direction may be determined based on trajectory points that are determined by the SLAM system carried by the XR device itself within a preset time period before the current moment. In this embodiment of the present disclosure, constructing the elliptical region based on the moving direction allows the walking trajectory of the user to coincide with the first region, so that the utilization of the first region is improved, and there are not a large number of blank spaces in the first region that the user does not reach, which can further save resources.

For example, after the first region is determined, the first preset number of frames or fewer frames of image frame data are stored in association with each grid of the first region. The specific process and related content described above are not repeated here.

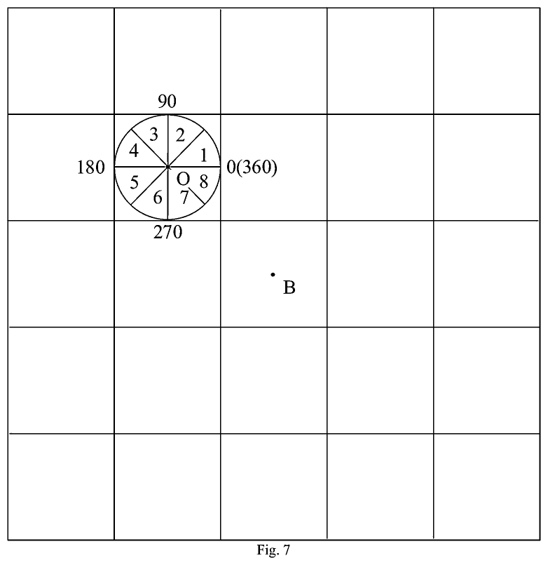

For example, as shown in FIG. 7, assuming that the user wears the XR device and walks to the point B, when an anchor placement request is received, a plurality of grids (e.g., 5*5) may be created with the point B as a center, and to further limit a number of images within each grid, a plurality of orientation ranges may be configured for the grid. Taking the second grid in the second row as an example, assuming that orientation ranges are obtained through division with a step of 45 degrees, eight sector regions can be obtained, which are 1 to 8 as shown in FIG. 7, and respectively correspond to eight orientation ranges, where an orientation range 1 may correspond to 0 to 45 degrees, an orientation range 2 may correspond to 45 to 90 degrees, and so on, and an orientation range 8 may correspond to 315 to 360 degrees. In actual applications, a number of frames of images retained by each sector region may be limited to 3, i.e. three frames of images are stored for each orientation range. Assuming that the user has acquired three frames of images for orientation angles of 10 degrees, 30 degrees, and 25 degrees, images subsequently acquired for the range of 0 degrees to 45 degrees are no longer stored.

It should be noted that, regardless of an acquisition position of an image frame in a grid, image frame data of the image frame is stored for a corresponding orientation range as long as an orientation angle corresponding to the acquisition position belongs to the orientation range. When a number of frames of filtered image frame data are visually displayed, as shown in FIG. 7, a circle may be created with a center point O of a grid as the center of the circle, and then the circle is divided into eighth sector regions, within each of which a number of frames of image frame data stored for a corresponding orientation range is displayed.

Then, the first map is constructed based on the image frame data stored in association with each of the plurality of squares in the first region, and the first anchor is bound to the first map.

Specifically, as an increasing number of frames of image frame data are stored in association with the grid, existing map construction techniques such as front-end feature point extraction and matching, triangulation, and BA may be used to construct the first map based on the image frame data stored in association with the grid. After the user steps out of the first region and the first map is constructed, the first anchor may be bound to the first map.

In an embodiment of the present disclosure, the first anchor is bound to the first map, so that the position coordinates of the first anchor in a map coordinate system of the first map may be calculated based on a transformation relationship between a target coordinate system corresponding to the SLAM system and the map coordinate system of the first map.

It can be learned from the above description that, according to the map construction method provided in this embodiment of the present disclosure, the region where the map is to be constructed is divided into grids and filtering is performed on the images based on the grids, and then the map is constructed based on a smaller number of filtered images, which can save resources and improve the efficiency of map construction.

In an embodiment of the present disclosure, the map construction method may further include: during a localization process, if the first map is located, obtaining a pose transformation relationship between the map coordinate system of the first map and a map coordinate system of the second map, determining, based on the pose transformation relationship, a first position coordinate of at least one anchor bound to the second map in the map coordinate system of the first map, and displaying, based on the first position coordinate, the at least one anchor bound to the second map.

For example, as shown in FIG. 8, assuming that a first map 601, a second map 602, and a third map 603 are constructed, after the device is restarted or the map construction is completed for preset duration, when the user steps into the region of the first map 601 again, the user may locate the first map 601, and an anchor bound to the first map 601 may be accurately displayed based on the map coordinate system of the first map. In order to enhance the sense of realism in experience, since anchors bound to the second map 602 and to the third map 603 are also moved with the user's line of sight, an anchor within a range of the user's line of sight may be displayed, and because the second map 602 and the third map 603 are at a distance from the user, the anchors bound to them may also be displayed based on the map coordinate system of the first map 601. Similarly, when the user steps into the region of the second map 602, the anchors bound to the first map 601, the second map 602, and the third map 603 are displayed based on the map coordinate system of the second map 602.

It can be learned from the above description that, according to the map construction method provided in this embodiment of the present disclosure, all anchors are displayed based on the map coordinate system of the map which is located during the localization process, which achieves a balance between the accuracy of anchor displaying and the sense of realism in user experience.

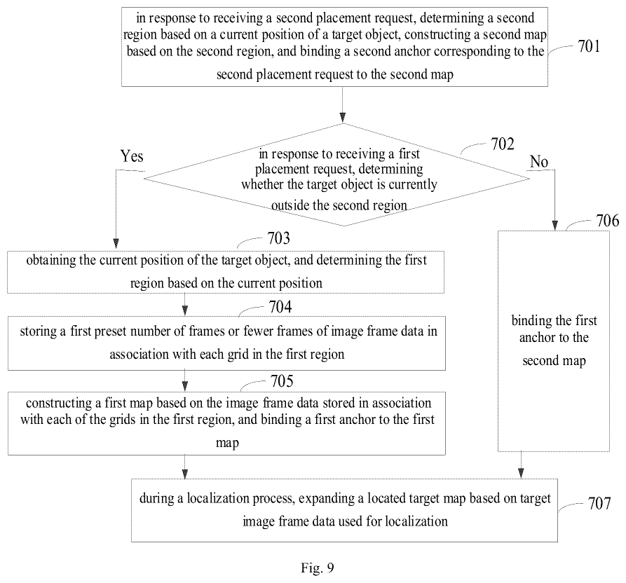

FIG. 9 is a schematic flowchart of a map construction method according to an embodiment of the present disclosure. On the basis of the above embodiments, this embodiment describes a process of map construction and localization comprehensively by way of example. The map construction method includes the following steps:

701: in response to receiving a second placement request, determining a second region based on a current position of a target object, constructing a second map based on the second region, and binding a second anchor corresponding to the second placement request to the second map.

Specifically, when a user wears an XR device and walks in a place, a mapping thread may not be started until there is a need for anchor placement; and when the first need for anchor placement occurs, the mapping thread may be started. Starting from a moment at which the user places an anchor, the mapping thread records a current position determined by the SLAM system of the XR device at the moment, and divides the second region into a plurality of grids (e.g., 5*5) with the current position as a center, where each of the grids may be further divided by an orientation angle, and each preset angle (e.g., 30 degrees) corresponds to one sector region. If the user keeps moving in the second region, acquired images are stored in association with corresponding grids and corresponding sector regions. In order to balance between map precision and resource occupancy, a maximum number of frames of images placed in each sector region may be limited to 3, and no additional frames of images will be added if there are more than three frames.

702: in response to receiving a first placement request, determining whether the target object is currently outside the second region.

If yes, step 703 is performed; otherwise, step 706 is performed.

703: obtaining the current position of the target object, and determining the first region based on the current position.

For example, the first region is divided into a plurality of grids, and the second region is determined in response to receiving the second placement request.

704: storing a first preset number of frames or fewer frames of image frame data in association with each grid in the first region.

705: constructing a first map based on the image frame data stored in association with each of the grids in the first region, and binding a first anchor to the first map.

For the specific process of step 702 to step 705 in this embodiment of the present disclosure, reference may be made to the related description in the foregoing embodiment, and details are not repeated here.

706: binding the first anchor to the second map.

Here, the second map is constructed based on the second region.

Specifically, when the user keeps walking in the second region, all anchor placement requests received may be used to bind a corresponding anchor to the second map. When the user steps out of the second region and a new anchor placement request is received, it is required to construct a new map to bind to a corresponding anchor.

707: during a localization process, expanding a located target map based on target image frame data used for localization.

For example, the target map is one of all historically constructed maps including the first map and the second map.

Specifically, when each map is constructed, although a corresponding grid region, for example, 5*5 grids, is constructed for the map, the user may walk through some grids, but has not walked through the remaining grids. It is assumed that the user has not walked through a grid a in the 25 grids. Then, when the user arrives at the grid a and image frame data is acquired, an association between the grid a and the corresponding image frame data may be stored in the grid a. It is assumed that the user has walked through a grid b, but a number of image frames stored in association with the grid b does not reach a threshold. Then, an image acquired during localization may be stored in association with the grid b when the user walks through the grid b again. Further, a new map may be constructed again based on image frame data stored in association with each grid, so as to update a previously constructed map.

In an embodiment of the present disclosure, existing localization techniques may be used during the localization process. For example, these techniques may include one or more steps of extraction of feature points, generation of bags of words, search for the most similar frames based on a bag of words in a map, feature point matching, pnp (Perspective-n-Points), and multi-frame consistency determination.

In an embodiment of the present disclosure, the expanding a located target map based on target image frame data used for localization may include: in response to the target map being located, determining a target grid corresponding to the target image frame data for localization from a plurality of grids of the target map, where the target map is a map among all historically constructed maps including the first map; and if a number of frames of image frame data stored in association with the target grid is less than or equal to a third preset number, storing the target image frame data in association with the target grid, and updating the target map based on the target image frame data, where the third preset number is less than or equal to the first preset number.

For example, it is assumed that a maximum number of frames of images stored in association with a grid c is limited to 30. If only 10 frames of image are stored for the grid c when the grid c is located, image frame data used for localization may then be stored in association with the grid c, in order to expand, based on the image frame data, a map constructed from a region to which the grid c belongs. For another example, taking a grid d as an example, 12 sector regions are obtained through division with a step of 30 degrees, and a maximum number of frames of images associated with each sector region is limited to 3. Then, when a sector region e of the grid d is located, if there are only two frames of images associated with the sector region e, an image used for localization may be stored in association with the sector region e to expand, based on the image, a map constructed from a region to which the grid d belongs.

It can be learned from the above description that, according to the map construction method provided in this embodiment of the present disclosure, the region that needs to construct map is divided into the grids and filtering is performed on the images based on the grids, and then the map is constructed based on a smaller number of filtered images, which can save resources and improve the efficiency of map construction; and during the localization process, the map is updated and expanded based on the image for localization, which can improve the precision of the map.

Map management may include: map construction, map update, map deletion, etc.

The map construction refers to creation of corresponding map data for an anchor, so that the anchor can be retrieved and displayed through the map data. The map update refers to updating an existing region map to improve precision of the map data, or to expand scope of the map data. The map deletion refers to deletion of temporarily unused map data to save a storage space.

In some solutions, as the user moves through the target region, a feature point of surroundings captured in real-time is matched with a feature point in the existing region map. When the match is successful, a virtual object bound to an anchor of the existing region map may be displayed based on information about the anchor; and when the match fails, map data for the region may be created and an anchor may be set, so that a successful match can be performed when the user arrives at the region again later.

However, the above solution has a problem of low precision of the map.

In order to solve the above problem, the map construction method provided in this embodiment of the present disclosure further includes updating the existing region map in units of subregions when the match is successful. In this way, continuous localization is achieved during movement of the user to determine whether there is a region map to be located. When there is a region map to be located, the region map may be updated based on a video frame feature point to improve the precision of the existing region map.

FIG. 10 is a schematic diagram of space division according to an embodiment of the present disclosure. Referring to FIG. 10, a space may be divided into four regions Q1, Q2, Q3, and Q4. Then, Q1, Q2, Q3, and Q4 correspond to region maps D1, D2, D3, and D4, respectively. All regions each have a fixed length, width, and height. For example, all regions may have a length of 5 meters, a width of 5 meters, and a height of 3 meters to divide the space into a plurality of regions of 5 meters×5 meters×3 meters.

In the scenario shown in FIG. 10, the region map in this embodiment of the present disclosure may be map data of a region obtained through the above division. For example, the region maps D1, D2, D3, and D4 may also be map data corresponding to an entire space formed by the region maps D1, D2, D3, and D4. After each start-up of a user terminal, the user moves with a transmit end in the space shown in FIG. 10, a region map of each region and an anchor corresponding to the region map may be constructed continuously, and region maps of regions constructed after this start-up may form a region map that corresponds to the entire space after this start-up. Thus, after the user terminal restarts N times, N region maps of the entire space may be obtained, where N is a positive integer greater than or equal to 1.

It may be understood that there is no overlapping region between different regions shown in FIG. 10, but in actual applications, an overlapping region may exist between different regions. One or more anchors may be set in each region, the region corresponds to one region map, and the region map corresponds to one or more anchors. Setting a region map for an entire space has accumulated drift in a simultaneous localization and mapping (SLAM) scenario, and results in poor accuracy. In contrast, the region map in this embodiment of the present disclosure is local map data, which makes it possible to avoid accumulated drift and help to improve accuracy.

In addition, the use of the local map data further has the following advantages:

First, there is no need to construct a region map for a region without an anchor, so that a storage space occupied by the region map can be reduced, and therefore, a storage space can be effectively saved.

Second, each time a video frame feature point is matched with a region map, only a region map of a current region needs to be matched, involving a small amount of data for matching, which in turn improves matching efficiency.

Third, when an anchor is shared, local map data associated with the anchor may be shared, involving a small amount of data, which can improve efficiency of anchor sharing.

Fourth, compared to having each piece of local map data correspond to only one anchor, having one piece of local map data to correspond to a plurality of anchors can effectively avoid duplication of region maps, which further saves a storage space.

In this embodiment, the region map is map data formed based on a feature point of an environment, and may be understood as a point cloud map that is three-dimensional. The feature point is a point in the video frame with a relatively high contrast and a distinct feature, for example, it may be a corner feature point, an object feature point, etc.

For example, in some examples, before the determining, in response to a second region map not being located at a current moment, a boundary range of a first region map based on the first placement position and constructing the first region map based on the boundary range of the first region map, the map construction method provided in this embodiment of the present disclosure further includes: acquiring a video frame feature point from a physical environment; based on the video frame feature point and an acquisition position in which a video frame corresponding to the video frame feature point is acquired, determining, from at least one existing region map, whether the second region map is located, where the second region map matches the video frame feature point, the acquisition position is within a third region defined by a boundary range of the second region map, and the third region includes at least one subregion; and in response to the second region map being located at the current moment, when a target object reaches a first subregion in the at least one subregion, updating sub data of the first subregion in the second region map based on the video feature point.

For example, in response to the second region map not being located at the current moment, video frame feature points for a preset number of video frames are cached, and during the construction of the first region map, the first region map is constructed based on the video frame feature points for the preset number of video frames.

For example, a physical environment is the real surroundings of the current position of the user. When the user, carrying an electronic device, moves in a space, the electronic device may acquire video frames in real-time that represent real surroundings of the current position of the user in the space. In this way, these continuously acquired video frames constitute a video. Thus, a feature point may be extracted from each video frame as a video frame feature point for the video frame.

The video frame may be grayscale images, red-green-blue (RGB) images, depth images, structured light images, etc.

Each time a video frame feature point is acquired for a video frame, a region map corresponding to the video frame may be obtained. A process of acquiring a region map for each video frame is to perform a first match between each existing region map and a video frame feature point for the video frame, and to perform a second match between a target region defined by a boundary range of the existing region map and an acquisition position. If the first match and the second match are successful, it indicates that the existing region map and the video frame feature point are successfully matched, and then the existing region map is used as the region map for the video frame. If the first match and/or the second match fails, it indicates that the existing region map is not matched with the video frame feature point. If all existing region maps are not matched with the video frame feature point, it indicates that there is no corresponding region map for the video frame.

For example, performing a second match between a third region of the existing region map and the acquisition position may include: determining whether the acquisition position is in the third region; and if the acquisition position is in the third region, determining that the second match is successful; or if the acquisition position is outside the third region, determining that the second match fails.

For example, each existing region map is divided into at least one subregion, so that the third region also includes at least one subregion, so that the third region is to be updated in units of subregions, helping to improve update efficiency and update accuracy.

Reaching the first subregion of the at least one subregion is: the acquisition position in the first subregion. Thus, during the process of the target object moving within the third region, sub-data for the first subregion may be updated each time the first subregion is reached. Specifically, there are a plurality of cases of updating the sub-data for the first subregion.

Case 1: The sub-data for the first subregion is missing, so that a feature point may be extracted from the video frame to obtain feature point data, and then the feature point data may be added, as the sub-data for the first subregion, to the second region map.

Case 2: The sub-data for the first subregion exists, so that a feature point may be extracted from the video frame and extracted feature point data may be compared to the sub-data for the first subregion, and a feature point that exists in the video frame feature point but does not exist in the sub-data for the first subregion is added to sub-data of the first subregion in the second region map.

In some implementations, the third region includes at least one subregion obtained through division by a preset angle.

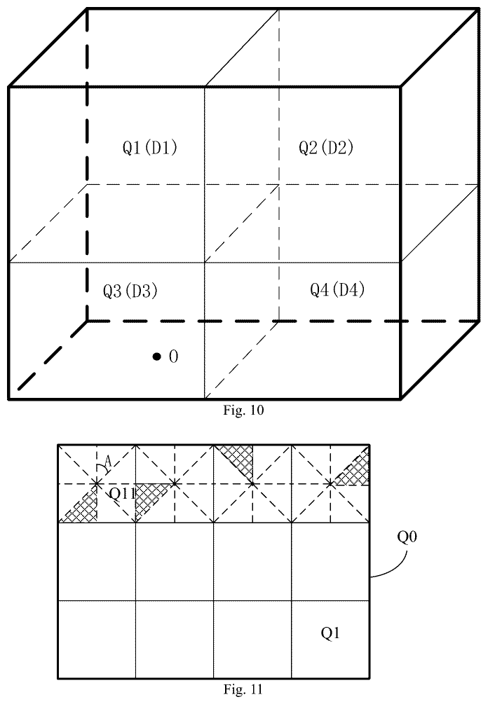

FIG. 11 is a schematic diagram of a top view of space division according to an embodiment of the present disclosure. Referring to FIG. 11, the space Q0 is divided into 12 regions Q1 (e.g., the third region), with each region Q1 being divided by a preset angle A to obtain eight first subregions Q11.

It can be seen that both the space Q0 and the region Q1 are rectangular regions, and the subregion Q11 is triangular.

Referring to FIG. 11, a shadow region is a subregion for which sub-data exists, and when the target object reaches the shadow region, its sub-data may be updated by a video frame feature point. When the target object reaches a subregion of a non-shadow region, its sub-data may be created by a video frame feature point.

As can be seen from the above description, the subregion and the third region can be understood as being obtained through the two-layer region division of a space, so that this embodiment of the present disclosure makes it possible to achieve more refined map management first by the two-layer region division, which can not only improve the update efficiency of map data, but also improve the accuracy of map data.

For example, in some examples, the determining, from at least one existing region map, whether the second region map is located may include: determining a quality parameter for each existing region map; and determining the second region map from the at least one existing region map based on the quality parameter, where the second region map is an existing region map having the greatest quality parameter, and the quality parameter includes at least one of: a number of feature points included in the existing region map, an amount of data of the existing region map, a number of video frames corresponding to the existing region map, a number of anchors corresponding to the existing region map, and an anchor type corresponding to the existing region map, the anchor type being used to indicate whether an anchor is used for room calibration.

For example, a greater quality parameter indicates better quality of the existing region map, and the quality parameter is positively correlated with the number of feature points, the amount of data, the number of video frames, and the number of anchors. The anchor type may be represented by 0 and 1, 0 indicates that the anchor is not used for room calibration, and 1 indicates that the anchor is used for room calibration. If at least one anchor of an existing region map is an anchor for room calibration, the existing region map is an existing region map for room calibration; and if none of the anchors of an existing region map is an anchor used for room calibration, the existing region map is an existing region map that is not used for room calibration. The existing region map used for room calibration has a larger quality parameter, and the existing region map not used for room calibration has a smaller quality parameter.

For example, in some other examples, the determining, from at least one existing region map, whether the second region map is located may include: determining, from the at least one existing region map during a first time period and at a first frequency, whether the second region map is located; and determining, from the at least one existing region map during a second time period and at a second frequency, whether the second region map is located, where the first frequency is higher than the second frequency; and the first time period includes: a time period after entering the third region, a time period after starting a target application, and a time period after the target application requests to query for an unrecognized anchor, and the second time period is a time period other than the first time period.

For example, the first frequency and the second frequency are frequencies at which the second region map is determined, that is, frequencies at which the video frame feature point is matched with the existing region map. Specifically, if a match between a video frame feature point and an existing region map is performed every K video frames, a frequency at which a match between a video frame feature point and an existing region map is performed is K. When a frame rate of a video is L frames per second, it can also be considered that a match between a video frame feature point and an existing region map is performed every K/L seconds, so that the frequency at which a match between a video frame feature point and an existing region map is performed may alternatively be K/L seconds. For example, when K is 120 and L is 120 frames per second, K/L=120/120=1 second, so that a first frequency at which a match between a video frame feature point and an existing region map is performed may be 120 video frames or 1 second. For another example, when K is 1200 and L is 120 frames per second, K/L=1200/120=10 seconds, so that a second frequency at which a match between a video frame feature point and an existing region map is performed may be 1200 video frames or 10 seconds.

In order to reduce the storage space occupied by the map data, the existing region map may be deleted according to a specific strategy. Specifically, when there are existing region maps satisfying a deletion condition, some of the existing region maps are deleted in units of map groups. According to this embodiment of the present disclosure, the map deletion is performed in units of map groups, which can improve deletion efficiency as much as possible and save storage space more quickly.

For example, in this embodiment of the present disclosure, region maps with a relatively small overlapping region are set as a map group, so that the region maps may be managed in units of map groups when the region maps are stored independently, which can improve efficiency in the management of the region maps.

The deletion condition may include at least one of the following: the amount of data of the existing region map being greater than or equal to a first preset threshold, a number of first map groups in the existing region maps being greater than or equal to a second preset threshold, an amount of data of the first map group being greater than or equal to a third preset threshold, and an amount of data of a second map group in the existing region maps being greater than or equal to a fourth preset threshold. The first map group includes map data corresponding to the anchor used for room calibration, and the second map group is a map group other than the first map group in the existing region maps.

The first preset threshold is used to limit the amount of data of the existing region maps to ensure that the amount of data of the existing region map is always within the first preset threshold, which can effectively reduce the storage space occupied by the existing region maps. The first preset threshold may be set flexibly based on a memory size of a storage device, for example, the first preset threshold may be set to 800 MB (megabits).

The second preset threshold is used to limit the number of first map groups, the first map group is a map group to which the existing region map used for room calibration belongs, so that it is ensured that the number of map groups used for room calibration is within the second preset threshold so as not to be excessively large, which facilitates management of the first map group and also makes it possible to save storage space. The second preset threshold may be set flexibly, for example, it may be set to 10 or 20. As such, when it is required to create a new first map group if the number of first map groups is greater than or equal to the second preset threshold, it may be prompted that some of the first map groups are required to be deleted before creating a new first map group, so that a strategy of occupying and deleting at the same time can be implemented, instead of directly deleting all first map groups at one time.

The third preset threshold is used to limit the amount of data of the first map group, to ensure that the amount of map data used for room calibration is within the third preset threshold so that the following case is avoided: a large storage space is occupied due to excessive amounts of data thereof. The third preset threshold may be set flexibly, for example, it may be set to 500 MB. Similarly, if the amount of data of the first map group is greater than or equal to the third preset threshold, it is required to delete some of the first map groups before creating a first map group.

The fourth preset threshold is used to limit the amount of data of the second map group, the second map group is a map group to which the existing region map not used for room calibration belongs, to ensure that the amount of map data not used for room calibration is within the fourth preset threshold, so that the following case is avoided: a large storage space is occupied due to excessive amounts of data thereof. The fourth preset threshold may be set flexibly, for example, it may be set to 500 MB. Similarly, if the amount of data of the second map group is greater than or equal to the fourth preset threshold, it is required to delete some of the second map groups before creating a second map group.

One or more map groups may be deleted randomly when the above deletion condition is satisfied, or the map group may be deleted according to the following strategy. First, basic information respectively corresponding to each existing region map is obtained, and the basic information includes at least one of the following: duration of existence, duration of use, and a number of anchors; then, a deletion index of the existing region map is determined based on the basic information, where the deletion index is positively correlated with the duration of existence, the deletion index is negatively correlated with the duration of use, and the deletion index is negatively correlated with the number of anchors; and finally, a third map group is deleted from the existing region maps, where the third map group includes an existing region map having the largest deletion index. Deletion by means of the deletion index allows for preferentially deleting a map group having a long duration of existence, short duration of use, and a small number of anchors, and retaining a map group having a short duration of existence, long duration of use, and a large number of anchors. It can avoid deletion of a useful map group as much as possible, ensuring normal use of the map group.

In some implementations, usage for each post-construction time may be weighted by the duration between one or more post-construction times of the existing region map and a construction time of the existing region map, and a weighted result may be used as the duration of use of the existing region map. Further, the duration of the existence of the existing region map is determined by the duration of existence respectively corresponding to the one or more post-construction times of the existing region map. Then, an activity level of the existing region map is determined by the duration of existence and the duration of use of the existing region map. Finally, the deletion index of the existing region map is determined by the activity level and the number of anchors of the existing region map.

The activity level of the existing region map is negatively correlated with the duration of existence, and the activity level of the existing region map is positively correlated with the duration of use. The deletion index is negatively correlated with the activity level of the existing region map. In this way, an existing region map with a low activity level and a small number of anchors is preferentially deleted.

In particular, the deletion index of the existing region map may be calculated by:

$$Z = \frac{1}{M \cdot \frac{{\sum }_{i = 1}^{N} X ( i ) \cdot i}{{\sum }_{i = 1}^{N} i}} \qquad ( 3 )$$

where Z is a deletion index of an existing region map, M is a number of anchors of the existing region map, N is duration from a creation time of the existing region map to a current time, and may be expressed in days, i is a positive integer greater than or equal to 1 and less than or equal to N, and X (i) represents whether an existing region map is used at the i^{th} post-construction time (i.e., the i^{th} day after construction), and specifically, it may be whether a match with a video frame feature point is successful at the i^{th} post-construction time, and if the match is successful, X(i) is 1, otherwise, X(i) is 0. It should be noted that i=1 represents a day when the existing region map is constructed, and i=2 represents a day after the existing map is constructed.

It can be seen from the above formula (3) that

$${\sum }_{i = 1}^{N} X ( i ) \cdot i$$

can be understood as duration of use of existing map data obtained through weighting,

$${\sum }_{i = 1}^{N} i$$

can be understood as duration of existence of the existing map data, and

$$\frac{{\sum }_{i = 1}^{N} X ( i ) \cdot i}{{\sum }_{i = 1}^{N} i}$$

can be understood as an activity level of the existing map data. The activity level takes into account both a number of times the existing map data is used and the duration of existence of the existing map data when using the existing map data. By normalizing

$${\sum }_{i = 1}^{N} X ( i ) \cdot i$$

with

$${\sum }_{i = 1}^{N} i ,$$

the deletion indexes of different existing map data are comparable, thereby ensuring accuracy of deleting map data based on the deletion indexes.

After the existing region map is constructed, usage of the existing region map has increasing impact on the deletion index over time. For example, for the i^{th} day after the existing region map is constructed and the j^{th} day after the i^{th} day, if the existing region map is used on both the i^{th} day and the j^{th} day, the use on the j^{th} day may reduce the deletion index to a greater extent. For another example, for the i^{th} day after the existing region map is constructed, using the existing region map on the i^{th} day may reduce the deletion index while not using the existing region map on the i^{th} day may not. In this way, it is possible to preferentially delete a map group to which an existing region map with a time of use closer to a construction time belongs, but also to retain old important map data.

It can be seen that in this embodiment of the present disclosure, instead of directly determining the deletion index by a total number of days of use after construction, the deletion index is determined by weighting the usage for each post-construction time with the duration between one or more post-construction times of the existing region map and a construction time of the existing region map, so that the deletion index can be more accurately represented, thereby improving deletion accuracy of existing region maps.

It should be noted that, in a power-off and/or sleep mode, it may be determined whether an existing region map has an anchor, and if there is no anchor, the existing region map may be deleted. In addition, in the power-off and/or sleep mode, redundant data may be deleted, where the redundant data is map data in a part of a processing layer. In this embodiment of the present disclosure, the processing layer includes an application layer, a software development kit (SDK) layer, an algorithm layer, or the like, and if an existing region map exists only in a part of the processing layer, complete processing of the existing region map cannot be achieved, so that the existing region map and a corresponding anchor may be deleted for saving a storage space.

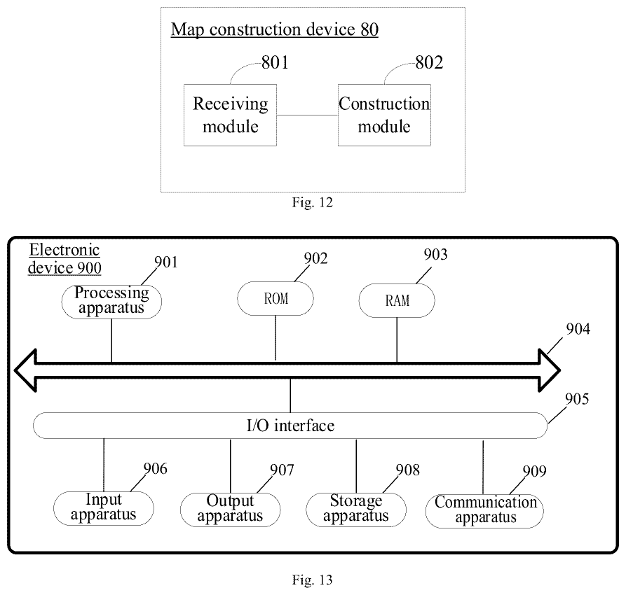

Corresponding to the map construction method in the above embodiment, FIG. 12 is a block diagram of a structure of a map construction device according to an embodiment of the present disclosure. For ease of illustration, only parts related to this embodiment of the present disclosure are shown. Referring to FIG. 12, the device includes: a receiving module 801 and a construction module 802.

The receiving module 801 is configured to receive a first placement request, where the first placement request includes a first placement position of a first anchor in a target coordinate system.

The construction module 802 is configured to determine, in response to a second region map not being located at a current moment, a boundary range of a first region map based on the first placement position and construct the first region map based on the boundary range of the first region map, and bind the first anchor to the first region map, where the second region map is constructed based on a placement request for placing an anchor that is received before the current moment.

In an embodiment of the present disclosure, the construction module 802 is specifically configured to: determine the boundary range of the first region map by using the first placement position as a center.

In an embodiment of the present disclosure, the construction module 802 is specifically configured to: determine a target position of the first anchor in a map coordinate system of the first region map based on the first placement position and a transformation relationship between the map coordinate system of the first region map and the target coordinate system, and place the first anchor based on the target position.

In an embodiment of the present disclosure, the boundary range of the first region map has a corresponding maximum accumulated drift error less than a preset threshold.

In an embodiment of the present disclosure, the construction module 802 is further configured to: in response to the second region map being located at the current moment, bind the first anchor to the second region map.

In an embodiment of the present disclosure, the construction module 802 is further configured to: in response to the second region map being located at the current moment, and the second region map overlapping with the first region map, merge the second region map with the first region map.

In an embodiment of the present disclosure, the construction module 802 is specifically configured to: correct the first region map to merge a corrected first region map with the second region map.

In an embodiment of the present disclosure, the construction module 802 is specifically configured to: determine a plurality of historical region maps constructed between a first moment and a second moment, where the second moment is a moment at which the second region map is currently located, the first moment is a moment at which the second region map is located last time before the second moment, and each of the plurality of historical region maps is constructed based on a placement request for placing an anchor; construct a total error function based on a loop closure formed by an origin of a map coordinate system of the second region map and origins of map coordinate systems of the plurality of historical region maps; obtain a target pose transformation relationship, between a map coordinate system of the first region map and the target coordinate system, that minimizes the total error function; and determine the corrected first region map based on the target pose transformation relationship, where the target coordinate system is a coordinate system for self-tracking and localization.

In an embodiment of the present disclosure, the construction module 802 is specifically configured to: obtain at least one first pose transformation relationship that respectively corresponds to at least one adjacent map pair, where each adjacent map pair includes two adjacent region maps in the plurality of historical region maps and the second region map, and a first pose transformation relationship corresponding to the adjacent map pair is a pose transformation relationship between map coordinate systems of the two adjacent region maps; for each adjacent map pair, determine an accumulated error term corresponding to the adjacent map pair based on the first pose transformation relationship corresponding to the adjacent map pair and a second pose transformation relationship between the map coordinate system corresponding to each of the two region maps and the target coordinate system; and determine the total error function based on the accumulated error term respectively corresponding to the at least one adjacent map pair.

For example, a region determined based on the boundary range of the first region map is divided into a plurality of grids. In an embodiment of the present disclosure, the construction module 802 is specifically configured to: for each grid, store image frame data in association with the grid, where a count of frames in the image frame data with the grid is less than or equal to a first preset number; and construct the first region map based on the image frame data stored in association with each of the plurality of grids.

For example, in an embodiment of the present disclosure, the construction module 802 is specifically configured to: for each grid, assign a plurality of orientation ranges to the grid, where each orientation range represents a range to which an orientation angle corresponding to the image frame data belongs; and store a second preset number of frames or fewer frames of image frame data in association with each orientation range of each grid, where the second preset number is less than the first preset number.

Each grid in the first region map comprises at least one sector region with a center of the grid as a circle's center and with a central angle being a preset angle, and different sector regions correspond to different orientation angles. The construction module 802 is further specifically configured to: display the at least one sector region distinguishably based on a number of frames of image frame data stored in association with the each sector region.

In an embodiment of the present disclosure, the construction module 802 is further specifically configured to: obtain a target region, where the target region includes a first region and a second region, and the target region is divided into a plurality of grids; in response to a target object being currently located outside the second region, obtain a current position of the target object, and determine the first region based on the current position, where the first region is divided into a plurality of grids, and the second region is determined in response to receiving a second placement request; store a first preset number of frames or fewer frames of image frame data in association with each grid; and construct a first map based on the image frame data stored in association with each of the plurality of grids in the first region, and bind the first anchor to the first map.

In an embodiment of the present disclosure, the construction module 802 is further specifically configured to: in response to the target object being currently located in the second region, bind the first anchor to a second map, where the second map is constructed based on the second region.

In an embodiment of the present disclosure, the construction module 802 is further specifically configured to: during a localization process, in response to the first map being located, obtain a pose transformation relationship between a map coordinate system of the first map and a map coordinate system of the second map; determine, based on the pose transformation relationship, position coordinates of at least one anchor bound to the second map in the map coordinate system of the first map; and display, based on the position coordinates of the at least one anchor in the map coordinate system of the first map, the at least one anchor bound to the second map.

In an embodiment of the present disclosure, the map construction device further includes an expansion module. The expansion module is configured to, during a localization process, expand a located target map based on target image frame data used for localization, where the target map is a map among all historically constructed maps including the first map.

In an embodiment of the present disclosure, the expansion module is specifically configured to: in response to the target map being located, determine a target grid corresponding to the target image frame data from a plurality of grids of the target map; and in response to a number of frames of image frame data stored in association with the target grid being less than or equal to a third preset number, store the target image frame data in association with the target grid, and update the target map based on the target image frame data, where the third preset number is less than or equal to the first preset number.

In an embodiment of the present disclosure, the map construction device further includes an update module. The update module is configured to acquire a video frame feature point from a physical environment; based on the video frame feature point and an acquisition position in which a video frame corresponding to the video frame feature point is acquired, determine, from at least one existing region map, whether the second region map is located, where the second region map matches the video frame feature point, the acquisition position is within a third region defined by a boundary range of the second region map, and the third region includes at least one subregion; and in response to the second region map being located at the current moment, when a target object reaches a first subregion in the at least one subregion, update sub-data of the first subregion in the second region map based on the video feature point; or in response to the second region map not being located at the current moment, caching video frame feature points for a preset number of video frames, and during construction of the first region map, construct the first region map based on the video frame feature points for the preset number of video frames.

The device provided in this embodiment may be configured to perform the technical solution of the above method embodiment. The implementation principle and technical effects thereof are similar, and are not described herein again in this embodiment.

To implement the above embodiments, an embodiment of the present disclosure further provides an electronic device.

FIG. 13 is a schematic diagram of a structure of an electronic device 900 suitable for implementing the embodiments of the present disclosure. The electronic device 900 may be a terminal device or a server. The terminal device may include, but is not limited to, a mobile terminal such as a mobile phone, a notebook computer, a digital broadcast receiver, a personal digital assistant (PDA), a tablet computer (portable Android device, PAD), a portable media player (PMP), and a vehicle-mounted terminal (such as a vehicle navigation terminal), and a fixed terminal such as a digital TV and a desktop computer. The electronic device shown in FIG. 13 is merely an example, and shall not impose any limitation on the function and scope of use of the embodiments of the present disclosure.

As shown in FIG. 13, the electronic device 900 may include a processing apparatus (e.g., a central processing unit or a graphics processing unit) 901 that may perform a variety of appropriate actions and processing in accordance with a program stored in a read-only memory (ROM) 902 or a program loaded from a storage apparatus 908 into a random access memory (RAM) 903. The RAM 903 further stores various programs and data required for the operation of the electronic device 900. The processing apparatus 901, the ROM 902, and the RAM 903 are connected to one another through a bus 904. An input/output (I/O) interface 905 is also connected to the bus 904.

Generally, the following apparatuses may be connected to the I/O interface 905: an input apparatus 906 including, for example, a touchscreen, a touchpad, a keyboard, a mouse, a camera, a microphone, an accelerometer, and a gyroscope; an output apparatus 907 including, for example, a liquid crystal display (LCD), a speaker, and a vibrator; the storage apparatus 908 including, for example, a tape and a hard disk; and a communication apparatus 909. The communication apparatus 909 may allow the electronic device 900 to perform wireless or wired communication with other devices to exchange data. Although FIG. 13 shows the electronic device 900 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded and installed from a network through the communication apparatus 909, installed from the storage apparatus 908, or installed from the ROM 902. When the computer program is executed by the processing apparatus 901, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the method shown in the above embodiment.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user via any kind of network, including a local area network (LAN) or a wide area network (WAN), or may be connected to an external computer (for example, connected via the Internet with the aid of an Internet service provider).

At least one embodiment of the present disclosure provides a map construction method. The method includes: receiving a first placement request, where the first placement request includes a first placement position of a first anchor in a target coordinate system; and determining, in response to a second region map not being located at a current moment, a boundary range of a first region map based on the first placement position and constructing the first region map based on the boundary range of the first region map, and binding the first anchor to the first region map, where the second region map is constructed based on a placement request for placing an anchor that is received before the current moment.

In one or more embodiments of the present disclosure, the determining a boundary range of a first region map based on the first placement position includes: determining the boundary range of the first region map by using the first placement position as a center.

In one or more embodiments of the present disclosure, the binding the first anchor to the first region map includes: determining a target position of the first anchor in a map coordinate system of the first region map based on the first placement position and a transformation relationship between the map coordinate system of the first region map and the target coordinate system, and placing the first anchor based on the target position.

In one or more embodiments of the present disclosure, the boundary range of the first region map has a corresponding maximum accumulated drift error less than a preset threshold.

In one or more embodiments of the present disclosure, after the receiving a first placement request, the method further includes: in response to the second region map being located at the current moment, binding the first anchor to the second region map.

In one or more embodiments of the present disclosure, after the binding the first anchor to the first region map, the method further includes: in response to the second region map being located at the current moment, and the second region map overlapping with the first region map, merging the second region map with the first region map.

In one or more embodiments of the present disclosure, the merging the second region map with the first region map includes: correcting the first region map to merge a corrected first region map with the second region map.

In one or more embodiments of the present disclosure, the correcting the first region map includes: determining a plurality of historical region maps constructed between a first moment and a second moment, where the second moment is a moment at which the second region map is currently located, the first moment is a moment at which the second region map is located last time before the second moment, and each of the plurality of historical region maps is constructed based on a placement request for placing an anchor; constructing a total error function based on a loop closure formed by an origin of a map coordinate system of the second region map and origins of map coordinate systems of the plurality of historical region maps; obtaining a target pose transformation relationship, between a map coordinate system of the first region map and the target coordinate system, that minimizes the total error function; and determining the corrected first region map based on the target pose transformation relationship, where the target coordinate system is a coordinate system for self-tracking and localization.

In one or more embodiments of the present disclosure, constructing the total error function based on the loop closure formed by using the second region map and the plurality of historical region maps includes: obtaining at least one first pose transformation relationship that respectively corresponds to at least one adjacent map pair, wherein each adjacent map pair comprises two adjacent region maps in the plurality of historical region maps and the second region map, and a first pose transformation relationship corresponding to the adjacent map pair is a pose transformation relationship between map coordinate systems of the two adjacent region maps; for each adjacent map pair, determining an accumulated error term corresponding to the adjacent map pair based on the first pose transformation relationship corresponding to the adjacent map pair and a second pose transformation relationship between the map coordinate system corresponding to each of the two region maps and the target coordinate system; and determining the total error function based on the accumulated error term respectively corresponding to the at least one adjacent map pair.

In one or more embodiments of the present disclosure, a region determined based on the boundary range of the first region map is divided into a plurality of grids, and the constructing the first region map based on the boundary range of the first region map includes: for each grid, storing image frame data in association with the grid, wherein a count of frames in the image frame data with the grid is less than or equal to a first preset number; and constructing the first region map based on the image frame data stored in association with each of the plurality of grids.

In one or more embodiments of the present disclosure, the storing image frame data in association with the grid includes: for each grid, assigning a plurality of orientation ranges to the grid, where each orientation range represents a range to which an orientation angle corresponding to the image frame data belongs; and storing a second preset number of frames or fewer frames of image frame data in association with each orientation range of each grid, where the second preset number is less than the first preset number.

In one or more embodiments of the present disclosure, each grid in the first region map includes at least one sector region with a center of the grid as a center of a circle and with a central angle being a preset angle, and different sector regions correspond to different orientation angles; and after the constructing the first region map based on the image frame data stored in association with each grid of the plurality of grids, the method further includes: displaying the at least one sector region distinguishably based on a number of frames of image frame data stored in association with each sector region.

In one or more embodiments of the present disclosure, the method further includes: obtaining a target region, where the target region includes a first region and a second region, and the target region is divided into a plurality of grids; in response to a target object being currently located outside the second region, obtaining a current position of the target object, and determining the first region based on the current position, where the first region is divided into a plurality of grids, and the second region is determined in response to receiving a second placement request; storing a first preset number of frames or fewer frames of image frame data in association with each grid; and constructing a first map based on the image frame data stored in association with each of the plurality of grids in the first region, and binding the first anchor to the first map.

In one or more embodiments of the present disclosure, the method further includes: in response to the target object being currently located in the second region, binding the first anchor to a second map, where the second map is constructed based on the second region.

In one or more embodiments of the present disclosure, the method further includes: during a localization process, in response to the first map being located, obtaining a pose transformation relationship between a map coordinate system of the first map and a map coordinate system of the second map; determining, based on the pose transformation relationship, position coordinates of at least one anchor bound to the second map in the map coordinate system of the first map; and displaying, based on the position coordinates of the at least one anchor in the map coordinate system of the first map, the at least one anchor bound to the second map.

In one or more embodiments of the present disclosure, the method further includes: during a localization process, expanding a located target map based on target image frame data used for localization, where the target map is a map among all historically constructed maps including the first map.

In one or more embodiments of the present disclosure, the expanding a located target map based on target image frame data used for localization includes: in response to the target map being located, determining a target grid corresponding to the target image frame data from a plurality of grids of the target map; and in response to a number of frames of image frame data stored in association with the target grid being less than or equal to a third preset number, storing the target image frame data in association with the target grid, and updating the target map based on the target image frame data, where the third preset number is less than or equal to the first preset number.

In one or more embodiments of the present disclosure, before the determining, in response to a second region map not being located at a current moment, a boundary range of a first region map based on the first placement position and constructing the first region map based on the boundary range of the first region map, the method further includes: acquiring a video frame feature point from a physical environment; based on the video frame feature point and an acquisition position in which a video frame corresponding to the video frame feature point is acquired, determining, from at least one existing region map, whether the second region map is located, where the second region map matches the video frame feature point, the acquisition position is within a third region defined by a boundary range of the second region map, and the third region includes at least one subregion; and in response to the second region map being located at the current moment, when a target object reaches a first subregion in the at least one subregion, updating sub data of the first subregion in the second region map based on the video frame feature point.

At least one embodiment of the present disclosure provides an electronic device, including a processor and a memory, where the memory stores computer-executable instructions; and the processor executes the computer-executable instructions stored in the memory, to cause the processor to perform the map construction method according to any one of the embodiments of the present disclosure.

At least one embodiment of the present disclosure provides a computer-readable storage medium storing computer-executable instructions that, when executed by a processor, cause the map construction method according to any one of the embodiments of the present disclosure to be implemented.

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two internet protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A map construction method, comprising:
receiving a first placement request, wherein the first placement request comprises a first placement position of a first anchor in a target coordinate system; and
determining, in response to a second region map not being located at a current moment, a boundary range of a first region map based on the first placement position and constructing the first region map based on the boundary range of the first region map, and binding the first anchor to the first region map, wherein the second region map is constructed based on a placement request for placing an anchor that is received before the current moment.

2. The method according to claim 1, wherein the determining a boundary range of a first region map based on the first placement position comprises:
determining the boundary range of the first region map by using the first placement position as a center.

3. The method according to claim 1, wherein the binding the first anchor to the first region map comprises:
determining a target position of the first anchor in a map coordinate system of the first region map based on the first placement position and a transformation relationship between the map coordinate system of the first region map and the target coordinate system, and placing the first anchor based on the target position.

4. The method according to claim 1, wherein the boundary range of the first region map has a corresponding maximum accumulated drift error less than a preset threshold.

5. The method according to claim 1, wherein after the receiving a first placement request, the method further comprises:
in response to the second region map being located at the current moment, binding the first anchor to the second region map.

6. The method according to claim 1, wherein after the binding the first anchor to the first region map, the method further comprises:
in response to the second region map being located at the current moment, and the second region map overlapping with the first region map, merging the second region map with the first region map.

7. The method according to claim 6, wherein the merging the second region map with the first region map comprises:
correcting the first region map to merge a corrected first region map with the second region map.

8. The method according to claim 7, wherein the correcting the first region map comprises:
determining a plurality of historical region maps constructed between a first moment and a second moment, wherein the second moment is a moment at which the second region map is currently located, the first moment is a moment at which the second region map is located last time before the second moment, and each of the plurality of historical region maps is constructed based on a placement request for placing an anchor;
constructing a total error function based on a loop closure formed by an origin of a map coordinate system of the second region map and origins of map coordinate systems of the plurality of historical region maps;
obtaining a target pose transformation relationship, between a map coordinate system of the first region map and the target coordinate system, that minimizes the total error function; and
determining the corrected first region map based on the target pose transformation relationship, wherein the target coordinate system is a coordinate system for self-tracking and localization.

9. The method according to claim 8, wherein the constructing a total error function based on a loop closure formed by an origin of a map coordinate system of the second region map and origins of map coordinate systems of the plurality of historical region maps comprises:
obtaining at least one first pose transformation relationship that respectively corresponds to at least one adjacent map pair, wherein each adjacent map pair comprises two adjacent region maps in the plurality of historical region maps and the second region map, and a first pose transformation relationship corresponding to the adjacent map pair is a pose transformation relationship between map coordinate systems of the two adjacent region maps;
for each of the at least one adjacent map pair, determining an accumulated error term corresponding to the adjacent map pair based on the first pose transformation relationship corresponding to the adjacent map pair and a second pose transformation relationship between the map coordinate system corresponding to each of the two region maps and the target coordinate system; and
determining the total error function based on the accumulated error term respectively corresponding to the at least one adjacent map pair.

10. The method according to claim 1, wherein a region determined based on the boundary range of the first region map is divided into a plurality of grids; and
the constructing the first region map based on the boundary range of the first region map comprises:
for each grid, storing image frame data in association with the grid, wherein a count of frames in the image frame data with the grid is less than or equal to a first preset number; and
constructing the first region map based on the image frame data stored in association with each grid of the plurality of grids.

11. The method according to claim 10, wherein the storing image frame data in association with the grid comprises:
for each gird, assigning a plurality of orientation ranges to the grid, wherein each orientation range represents a range to which an orientation angle corresponding to the image frame data belongs; and
storing a second preset number of frames or fewer frames of image frame data in association with each orientation range of each grid, wherein the second preset number is less than the first preset number.

12. The method according to claim 11, wherein each grid in the first region map comprises at least one sector region with a center of the grid as a circle's center and with a central angle being a preset angle, and different sector regions correspond to different orientation angles; and
after the constructing the first region map based on the image frame data stored in association with each grid of the plurality of grids, the method further comprises:
displaying the at least one sector region distinguishably based on a number of frames of image frame data stored in association with each sector region.

13. The method according to claim 1, further comprising:
obtaining a target region, wherein the target region comprises a first region and a second region, and the target region is divided into a plurality of girds;
in response to a target object being currently located outside the second region, obtaining a current position of the target object, and determining the first region based on the current position, wherein the first region is divided into a plurality of grids, and the second region is determined in response to receiving a second placement request;
storing a first preset number of frames or fewer frames of image frame data in association with each grid; and
constructing a first map based on the image frame data stored in association with each of the plurality of girds in the first region, and binding the first anchor to the first map.

14. The method according to claim 13, further comprising:
in response to the target object being currently located in the second region, binding the first anchor to a second map, wherein the second map is constructed based on the second region.

15. The method according to claim 14, further comprising:
during a localization process, in response to the first map being located, obtaining a pose transformation relationship between a map coordinate system of the first map and a map coordinate system of the second map;
determining, based on the pose transformation relationship, a position coordinate of at least one anchor bound to the second map in the map coordinate system of the first map; and
displaying, based on the position coordinate of the at least one anchor in the map coordinate system of the first map, the at least one anchor bound to the second map.

16. The method according to claim 13, further comprising:
during a localization process, expanding a located target map based on target image frame data used for localization, wherein the target map is a map among all historically constructed maps comprising the first map.

17. The method according to claim 16, wherein the expanding a located target map based on target image frame data used for localization comprises:
in response to the target map being located, determining a target grid corresponding to the target image frame data from a plurality of grids of the target map; and
in response to a number of frames of image frame data stored in association with the target grid being less than or equal to a third preset number, associatively storing the target image frame data with the target grid, and updating the target map based on the target image frame data, wherein the third preset number is less than or equal to the first preset number.

18. The method according to claim 1, wherein before the determining, in response to a second region map not being located at a current moment, a boundary range of a first region map based on the first placement position and constructing the first region map based on the boundary range of the first region map, the method further comprises:
acquiring a video frame feature point from a physical environment;
based on the video frame feature point and an acquisition position in which a video frame corresponding to the video frame feature point is acquired, determining, from at least one existing region map, whether the second region map is located, wherein the second region map matches the video frame feature point, the acquisition position is within a third region defined by a boundary range of the second region map, and the third region comprises at least one subregion; and
in response to the second region map being located at the current moment, when a target object reaches a first subregion in the at least one subregion, updating sub-data of the first subregion in the second region map based on the video frame feature point.

19. An electronic device, comprising: a processor and a memory, wherein
the memory stores computer-executable instructions; and
the processor executes the computer-executable instructions stored in the memory, to cause the processor to perform a map construction method;
wherein the map construction method comprises:
receiving a first placement request, wherein the first placement request comprises a first placement position of a first anchor in a target coordinate system; and
determining, in response to a second region map not being located at a current moment, a boundary range of a first region map based on the first placement position and constructing the first region map based on the boundary range of the first region map, and binding the first anchor to the first region map, wherein the second region map is constructed based on a placement request for placing an anchor that is received before the current moment.

20. A computer-readable storage medium, storing computer-executable instructions that, when executed by a processor, cause a map construction method to be implemented;
wherein the map construction method comprises:
receiving a first placement request, wherein the first placement request comprises a first placement position of a first anchor in a target coordinate system; and
determining, in response to a second region map not being located at a current moment, a boundary range of a first region map based on the first placement position and constructing the first region map based on the boundary range of the first region map, and binding the first anchor to the first region map, wherein the second region map is constructed based on a placement request for placing an anchor that is received before the current moment.
